(19) United States
(12) Patent Application Publication
(10) Pub. No.: US 2026/0253185 A1
(43) Pub. Date: Aug. 27, 2026

(54) MEDIA DATA PROCESSING METHOD, APPARATUS, DEVICE, MEDIUM, AND PROGRAM PRODUCT

(71) Applicant: Beijing Zitiao Network Technology Co., Ltd., Beijing (CN)

(72) Inventors: Meng YAN, Beijing (CN); Haitao LV, Beijing (CN)

(21) Appl. No.: 19/551,213

(22) Filed: Feb. 26, 2026

(30) Foreign Application Priority Data
Feb. 27, 2025 (CN) 202510229266.1

(51) Int. Cl. G06T 5/73; G06F 3/0483; G06F 3/04845

(52) U.S. Cl. CPC G06T 5/73; G06F 3/0483; G06F 3/04845

(57) ABSTRACT

An embodiment of the present disclosure provides a media data processing method, apparatuses, a device, a medium, and a program product. The method includes: displaying original media data on a first page; acquiring reference media data in response to an interactive operation on the first page and determining a blur kernel according to a reference object in the reference media data, where a shape of the blur kernel is associated with the reference object; and performing blur processing on the original media data based on the blur kernel to obtain target media data, and displaying the target media data on the first page. The embodiment of the present disclosure solves the problem that the related art lacks a blurring solution for flexibly selecting the shape of the blur kernel, optimizes a lens blur solution for media data, and realizes flexible selection of the shape of the blur kernel.

### CROSS-REFERENCE TO RELATED APPLICATIONS

This application claims priority to Chinese Application No. 202510229266.1 filed on February 27, 2025, the disclosure of which is incorporated herein by reference in its entirety.

### TECHNICAL FIELD

Embodiments of the present disclosure relate to computer technologies, and in particular, to a media data processing method, an apparatus, a device, a medium, and a program product.

### BACKGROUND

Lens blur is a blur processing method used to simulate the out-of-focus imaging effect of a camera, that is, the natural blurring (such as the effect of light spots) generated in the out-of-focus area due to the characteristics of an optical lens. For example, performing lens blur processing on an original image based on a blur kernel, an image with a light spot effect can be obtained, which enriches the image display effect.

### SUMMARY

The present disclosure provides a media data processing method, an apparatus, a device, a medium, and a program product, which can flexibly select a shape of a blur kernel, thereby enriching a picture effect of target media data.

In a first aspect, an embodiment of the present disclosure provides a media data processing method, including:

displaying original media data on a first page;

acquiring reference media data in response to an interactive operation on the first page and determining a blur kernel according to a reference object in the reference media data, where a shape of the blur kernel is associated with the reference object;

performing blur processing on the original media data based on the blur kernel to obtain target media data, and displaying the target media data on the first page, where a shape of a light spot in the target media data is associated with the reference object.

In a second aspect, an embodiment of the present disclosure further provides a media data processing apparatus, including:

a displaying module, configured to display original media data on a first page;

a weight matrix determining module, configured to acquire reference media data in response to an interactive operation on the first page and determine a blur kernel according to a reference object in the reference media data, where a shape of the blur kernel is associated with the reference object; and

a blur processing module, configured to perform blur processing on the original media data based on the blur kernel to obtain target media data, and display the target media data on the first page, where a shape of a light spot in the target media data is associated with the reference object.

In a third aspect, an embodiment of the present disclosure further provides an electronic device, including:

one or more processors;

a storage, configured to store one or more programs,

when the one or more programs are executed by the one or more processors, the one or more processors are caused to implement the media data processing method according to any embodiment of the present disclosure.

In a fourth aspect, an embodiment of the present disclosure further provides a storage medium including computer-executable instructions, where when the computer-executable instructions are executed by a computer processor, the media data processing method according to any embodiment of the present disclosure is performed.

In a fifth aspect, an embodiment of the present disclosure further provides a computer program product, including a computer program, where when the computer program is executed by a processor, the media data processing method according to any embodiment of the present disclosure is implemented.

An embodiment of the present disclosure provides a media data processing solution. By displaying original media data on a first page, acquiring reference media data in response to an interactive operation on the first page, determining a blur kernel according to a reference object in the reference media data, performing blur processing on the original media data according to the blur kernel to obtain target media data, and displaying the target media data on the first page, since a shape of the blur kernel is associated with the reference object, blur kernels in different shapes may be determined according to different reference objects.

### BRIEF DESCRIPTION OF THE DRAWINGS

The above and other features, advantages, and aspects of the embodiments of the present disclosure will become more apparent in combination with the drawings and with reference to the following specific embodiments. Throughout the drawings, the same or similar reference numbers refer to the same or similar elements. It should be understood that the drawings are schematic, and that parts and elements are not necessarily drawn to scale.

FIG. 1 is a schematic flowchart of a media data processing method according to an embodiment of the present disclosure;

FIG. 2 is a schematic diagram of a page according to an embodiment of the present disclosure;

FIG. 3 is a schematic diagram of reference media data according to an embodiment of the present disclosure;

FIG. 4 is a schematic diagram of a first pixel point set according to an embodiment of the present disclosure;

FIG. 5 is a schematic diagram of a second pixel point set according to an embodiment of the present disclosure;

FIG. 6 is a combined diagram of a first pixel point set and a second pixel point set according to an embodiment of the present disclosure;

FIG. 7 is a schematic diagram of target media data according to an embodiment of the present disclosure;

FIG. 8 is a schematic flowchart of another media data processing method according to an embodiment of the present disclosure;

FIG. 9 is a schematic structural diagram of a media data processing apparatus according to an embodiment of the present disclosure; and

FIG. 10 is a schematic structural diagram of an electronic device according to an embodiment of the present disclosure.

### DETAILED DESCRIPTION OF EMBODIMENTS

Embodiments of the present disclosure are described in more detail hereinafter with reference to the drawings. The drawings illustrate some embodiments of the present disclosure, but it is to be understood that the present disclosure may be implemented in various manners and should not be construed as being limited to the embodiments set forth herein; on the contrary, these embodiments are provided for more thorough and complete understanding of the present disclosure. It is to be understood that the drawings and the embodiments of the present disclosure are illustrative and are not intended to limit the scope of the present disclosure.

It is to be understood that various steps recited in the method implementations of the present disclosure may be executed in a different order and/or in parallel. In addition, the method implementations may include additional steps and/or omit to perform illustrated steps. The scope of the present disclosure is not limited in this respect.

As used herein, the term "include/comprise" and variations thereof are open-ended inclusions, that is, "include/comprise but not limited to". The term "based on" is "at least partially based on". The term "an embodiment" means "at least one embodiment"; the term "another embodiment" means "at least one other embodiment"; and the term "some embodiments" means "at least some embodiments". Related definitions of other terms are given in the description hereinafter.

It is to be noted that the concepts of "first" and "second" etc. mentioned in the present disclosure are merely used to distinguish between different apparatuses, modules or units and are not used to limit the order of or interdependence between functions performed by these apparatuses, modules or units.

It is to be noted that the modifiers of "one" and "a plurality of" mentioned in the present disclosure are illustrative and not restrictive; those skilled in the art should understand that "one" or "a plurality of" should be understood as "one or more" unless clearly expressed in the context.

The names of messages or information exchanged between a plurality of apparatuses in the implementations of the present disclosure are for illustrative purposes only and are not intended to limit the scope of these messages or information.

It may be understood that before the use of the technical solutions disclosed in the embodiments of the present disclosure, the user should be informed of the type, range of use, use scenarios, etc. of personal information involved in the present disclosure and the authorization of the user should be obtained in an appropriate manner in accordance with relevant laws and regulations.

For example, in response to reception of an active request from a user, prompt information is sent to the user to clearly inform the user that the requested operation will require access to and use of personal information of the user. As such, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may also include a selection control for the user to choose whether to "agree" or "disagree" to provide the personal information to the electronic device.

It may be understood that the above process of notifying the user and acquiring authorization from the user is merely illustrative and does not limit the implementations of the present disclosure, and other manners that satisfy relevant laws and regulations may also be applied in the implementations of the present disclosure.

It may be understood that the data involved in the technical solution (including but not limited to the data itself, acquisition or use of the data) should comply with requirements of corresponding laws, regulations, and related provisions.

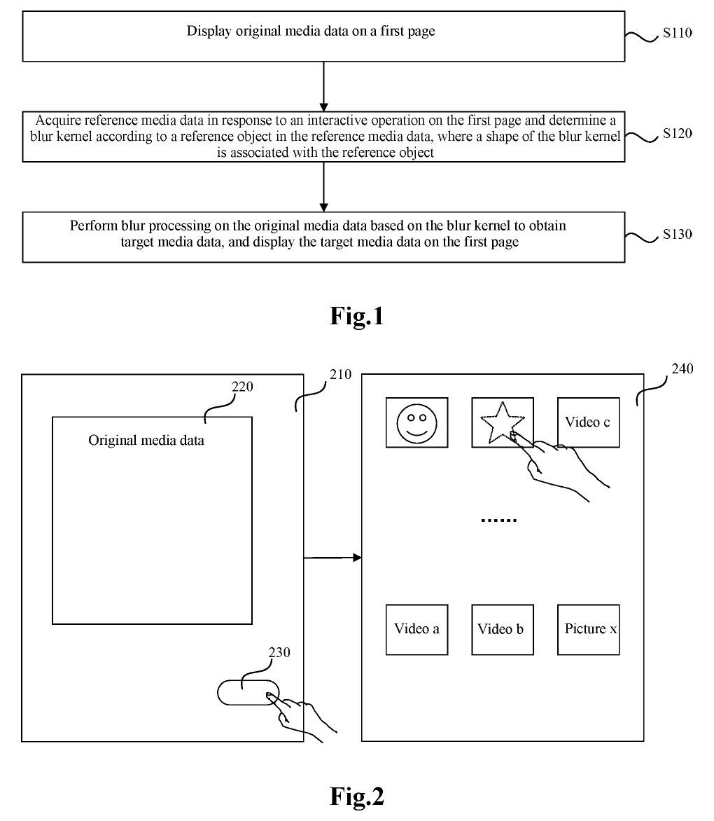

The related art lacks a blur processing solution for flexibly selecting the shape of the blur kernel. FIG. 1 is a schematic flowchart of a media data processing method according to an embodiment of the present disclosure. The embodiment of the present disclosure is applicable to a case of generating a lens blur effect for media data. The method may be performed by a media data processing apparatus which may be implemented in the form of software and/or hardware, and optionally, by an electronic device which may be a mobile terminal, a PC, a server, etc.

As shown in FIG. 1, the method includes:

S110, original media data is displayed on a first page.

The first page may be an image editing page. For example, the first page may be an editing page in a editing software. The original media data represents media data to be subjected to lens blur processing. The media data includes a picture or a video, etc. The original media data may be a shot picture or video. Optionally, the original media data may also be a picture or a video in a local media resource library. Optionally, the original media data may also include a downloaded picture or video. For example, the original media data may be a picture or a video downloaded from a web page, or may be a picture or a video downloaded from a chat record, etc.

S120, reference media data is acquired in response to an interactive operation on the first page and a blur kernel is determined according to a reference object in the reference media data, where a shape of the blur kernel is associated with the reference object.

The interactive operation on the first page may include a selection operation or an uploading operation on the reference media data. The reference media data refers to a picture or a video that includes the reference object. For example, the reference media data may be a picture or a video including a heart-shaped pattern. Alternatively, the reference media data may also be a picture or a video including a smiling face expression, etc. Optionally, the reference media data may also be a picture or a video uploaded by a user. The reference object refers to a subject in the reference media data. For example, a graphic drawn by the user may be used as the reference object, and a picture containing the drawn graphic may be used as the reference media data. The graphic drawn by the user may include a snowflake, a flower, a polygon, or the like. Alternatively, an object in a photo shot by the user may also be used as the reference object, and the shot photo may be used as the reference media data. The shot photo may be a photo of a water cup, a car, or the like.

The blur kernel is a weight matrix used in a blur processing procedure. Weighted summation processing is performed on pixel points in a local area in the original media data based on the blur kernel, to obtain a weighted summation result corresponding to the current local area. A pixel value of a current pixel point in the target media data is determined according to the weighted summation result corresponding to the current local area. The pixel value includes a luminance value of each color channel, etc. A sliding blur kernel is used to calculate weighted summation results of pixel points in each local area in the original media data, and a pixel value of each pixel point in the target media data is determined according to the weighted summation result corresponding to each local area, thereby obtaining the target media data. Elements of the blur kernel are weights in the weight matrix. The elements of the blur kernel may be determined according to luminance values of the pixel points in the reference object.

Exemplarily, acquiring the reference media data in response to the interactive operation on the first page includes: further displaying a first control on the first page; displaying a second page in response to a trigger operation on the first control, where the second page includes candidate media data, and the candidate media data includes the reference media data; and acquiring the reference media data in response to an interactive operation on the second page.

The candidate media data may include a picture or a video in a local media resource library. The candidate media data may include a picture or a video designed by the user and saved to the local media resource library. The candidate media data may also include a picture or a video downloaded by the user and saved to the local media resource library. The picture or the video may be a black-and-white image, or the picture or the video may be a color image. The second page is a display page of the media data in the local media resource library. The interactive operation on the second page may include at least one of the following operations: a selection operation for the reference media data on the second page, a sliding operation on the second page, and a reordering operation on the second page.

FIG. 2 is a schematic diagram of a page according to an embodiment of the present disclosure. As shown in FIG. 2, original media data 220 and a first control 230 are displayed on a first page 210. A second page 240 is displayed in response to a trigger operation on the first control 230. At least one candidate picture and/or at least one candidate video are displayed on the second page 240. A reference picture is acquired in response to an interactive operation on the second page. A star graphic in the reference picture is a reference object.

In some embodiments, determining the blur kernel according to the reference object in the reference media data includes: determining a binarization result of the reference media data; determining a weight matrix corresponding to the reference object according to luminance values of pixel points of the reference object in the binarization result; and determining the blur kernel according to the weight matrix corresponding to the reference object.

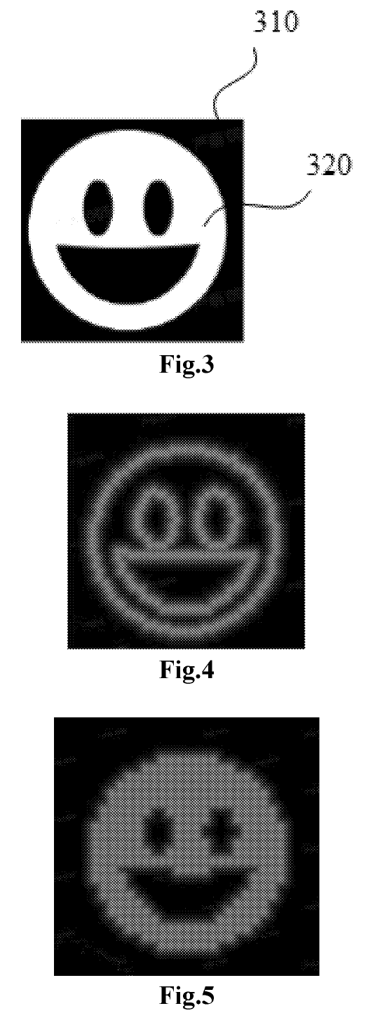

In a case that the reference media data is a black-and-white picture, the black-and-white picture is used as the binarization result of the reference media data. In a case that the reference media data is a black-and-white video, the black-and-white video is used as the binarization result of the reference media data. In a case that the reference media data is a color picture or a color video, the reference media data is binarized to obtain the binarization result of the reference media data. FIG. 3 is a schematic diagram of reference media data according to an embodiment of the present disclosure. As shown in FIG. 3, the reference media data 310 is a black-and-white picture, and the reference object is a smiling face 320.

In some embodiments, determining the weight matrix corresponding to the reference object according to the luminance values of the pixel points of the reference object in the binarization result includes: determining a first pixel point set and a second pixel point set in the binarization result, where a first pixel point in the first pixel point set represents a pixel point on a contour of the reference object, and a second pixel point in the second pixel point set represents a pixel point within the contour of the reference object; determining a weight of the first pixel point according to a luminance value of the first pixel point; determining a weight of the second pixel point according to a luminance value of the second pixel point; and determining the weight matrix corresponding to the reference object according to positions and weights corresponding to the first pixel point and the second pixel point.

Optionally, normalization processing may be performed on the luminance values, so that the value range of the luminance values of the first pixel point and the second pixel point is [0, 1], and a weight of a pixel point whose luminance value is close to 1 is greater than a weight of a pixel point whose luminance value is close to 0.

Since the positions of the elements in the weight matrix are determined based on the positions of the first pixel point and the second pixel point, and the first pixel point and the second pixel point represent the pixel points of the reference object, the shape of the blur kernel represented by the weight matrix is associated with the shape of the reference object. For example, if the reference object is a smiling face, the shape of the blur kernel is also a smiling face. If the reference object is heart-shaped, the shape of the blur kernel is also heart-shaped.

Taking the reference object being a smiling face as an example, the pixel points on the contour of the reference object may be acquired by an edge extraction algorithm, to obtain the first pixel point set. The first pixel point set includes a plurality of first pixel points. FIG. 4 is a schematic diagram of a first pixel point set according to an embodiment of the present disclosure. As shown in FIG. 4, the first pixel point set represents an edge contour of the smiling face. Sampling processing is performed on the pixel points within the contour of the reference object to obtain the second pixel point set. The second pixel point set includes a plurality of second pixel points. FIG. 5 is a schematic diagram of a second pixel point set according to an embodiment of the present disclosure. As shown in FIG. 5, the sampled edge of the smiling face has aliasing. FIG. 6 is a combined diagram of a first pixel point set and a second pixel point set according to an embodiment of the present disclosure. As shown in FIG. 6, the first pixel point set and the second pixel point set are fused, which may reduce the aliasing on the smiling face.

In the embodiment of the present disclosure, the edge contour of the reference object in the reference media data and the area inside the edge contour are separately sampled, and then the two parts of sampled pixel points are fused to obtain the sampling result, which may eliminate the aliasing generated by a small number of samplings, taking into account both the sampling performance and the picture effect of the sampling result.

Optionally, the first pixel point set and the second pixel point set are fused, to obtain a sampling result of the binarization result. A weight of a corresponding pixel point is determined according to a luminance value of each pixel point in the sampling result. The weight matrix corresponding to the reference object is determined according to the position and the weight of the pixel point in the sampling result.

Since the blur kernel of the lens blur is related to the luminance value of the pixel point in the sampling result, a greater luminance value corresponds to a greater weight.

In the case of a single channel, a weight of the first pixel point is determined according to the luminance value of the first pixel point in the sampling result. A weight of the second pixel point is determined according to the luminance value of the second pixel point in the sampling result. The weight matrix corresponding to the reference object is determined according to the positions and the weights of the first pixel point and the second pixel point.

Optionally, the luminance value includes a luminance value of the first pixel point or the second pixel point associated with at least one color channel, and the weight matrix represents a weight matrix associated with the at least one color channel.

In some embodiments, the color channel of the first pixel point or the second pixel point includes an R channel, a G channel, a B channel, and the like. The luminance value associated with the color channel refers to a luminance value (or referred to as a grayscale value) of the pixel point in the corresponding color channel. For example, a color value of the first pixel point being (20, 150, 255) represents that a luminance value associated with an R color channel of the first pixel point is 20, a luminance value associated with a G color channel of the first pixel point is 150, and a luminance value associated with a B color channel of the first pixel point is 255.

For the R color channel, a weight of the first pixel point in the weight matrix associated with the R color channel is determined according to the luminance value associated with the first pixel point and the R color channel. A weight of the second pixel point in the weight matrix associated with the R color channel is determined according to the luminance value associated with the second pixel point and the R color channel. The weight matrix associated with the R color channel of the reference object is determined according to the positions and the weights of the first pixel point and the second pixel point corresponding to the reference object.

For the G color channel, a weight of the first pixel point in the weight matrix associated with the G color channel is determined according to the luminance value associated with the first pixel point and the G color channel. A weight of the second pixel point in the weight matrix associated with the G color channel is determined according to the luminance value associated with the second pixel point and the G color channel. The weight matrix associated with the G color channel of the reference object is determined according to the positions and the weights of the first pixel point and the second pixel point corresponding to the reference object.

For the B color channel, a weight of the first pixel point in the weight matrix associated with the B color channel is determined according to the luminance value associated with the first pixel point and the B color channel. A weight of the second pixel point in the weight matrix associated with the B color channel is determined according to the luminance value associated with the second pixel point and the B color channel. The weight matrix associated with the B color channel of the reference object is determined according to the positions and the weights of the first pixel point and the second pixel point corresponding to the reference object.

It should be noted that a position of the weight in the weight matrix may be determined according to the position of the first pixel point or the second pixel point. The position in the weight matrix refers to a line number and a column number in the weight matrix.

In the case of multiple channels, the weight matrix associated with the R color channel of the reference object, the weight matrix associated with the G color channel of the reference object, and the weight matrix associated with the B color channel of the reference object are used as the blur kernel of the lens blur. It should be noted that the above example only takes the RGB three-channel as an example, and the above weight matrix determination method may also be applied to a scenario of four channels or more channels.

In some embodiments, determining the blur kernel according to the weight matrix corresponding to the reference object includes: adjusting at least part of the weights in the weight matrix corresponding to the reference object according to a preset adjustment coefficient, and determining the blur kernel according to the adjusted weight matrix. In the solution of this embodiment, each element in the weight matrix is multiplied by the preset adjustment coefficient, so that at least part of the weights in the weight matrix may be adjusted, and the effect of the light spot may be adjusted.

The elements in the weight matrix represent the weights corresponding to the first pixel point and the second pixel point. The preset adjustment coefficient may be a coefficient set according to an expected light spot effect. For example, in a case that the preset adjustment coefficient is 1, the weight matrix corresponding to the reference object is used as the blur kernel. In a case that the preset adjustment coefficient is a coefficient less than 1, a set element in the weight matrix corresponding to the reference object is multiplied by the preset adjustment coefficient to obtain the blur kernel. For example, a hollow light spot may be obtained by reducing the weight corresponding to the second pixel point in the weight matrix with a coefficient less than 1. A light spot with a clear edge may be obtained by increasing the weight corresponding to the first pixel point in the weight matrix with a coefficient greater than 1.

S130, blur processing is performed on the original media data based on the blur kernel to obtain target media data, and the target media data is displayed on the first page.

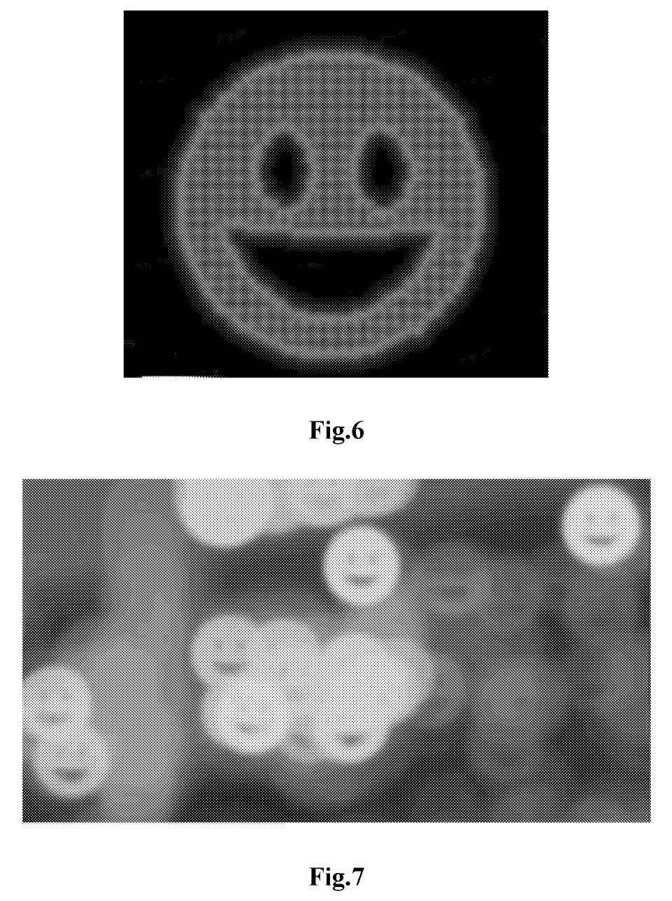

The blur processing is an image processing technique that weakens image details. In the embodiments of the present disclosure, the blur processing includes lens blur processing and the like. The target media data is a blur processing result of the original media data. The shape of the light spot in the target media data is associated with the shape of the blur kernel. For example, if the shape of the blur kernel is a smiling face, the shape of the light spot in the target media data is also a smiling face. FIG. 7 is a schematic diagram of target media data according to an embodiment of the present disclosure. As shown in FIG. 7, the shape of the light spot in the target media data is a smiling face.

Exemplarily, based on the weight matrix associated with the at least one color channel, convolution processing is performed on a luminance value of a color channel corresponding to the original media data to obtain a convolution result of the at least one color channel of the original media data; and the target media data is determined according to the convolution result of the at least one color channel of the original media data.

In the case of a single channel, convolution processing is performed on luminance values in a local area in the original media data based on the weight matrix, to obtain a luminance value of a pixel point in the target media data. The target media data is determined based on the luminance value of each pixel point in the target media data. The local area represents an area having the same shape as the shape of the blur kernel represented by the weight matrix.

In the case of multiple channels, convolution processing is performed on a luminance value of an R color channel in the original media data based on a weight matrix associated with the R color channel, to obtain a luminance value of an R color channel of a pixel point in the target media data. Convolution processing is performed on a luminance value of a G color channel in the original media data based on a weight matrix associated with the G color channel, to obtain a luminance value of a G color channel of the pixel point in the target media data. Convolution processing is performed on a luminance value of a B color channel in the original media data based on a weight matrix associated with the B color channel, to obtain a luminance value of a B color channel of the pixel point in the target media data. The target media data is determined based on luminance values corresponding to each pixel point in the target media data and the R color channel, the G color channel and the B color channel, respectively.

In the technical solution of the embodiment of the present disclosure, the original media data is displayed on the first page, the reference media data is acquired in response to the interactive operation on the first page, the blur kernel is determined according to the reference object in the reference media data, the blur processing is performed on the original media data according to the blur kernel to obtain the target media data, and the target media data is displayed on the first page. Since the shape of the blur kernel is associated with the reference object, blur kernels in different shapes may be determined according to different reference objects. The embodiment of the present disclosure solves the problem that the related art lacks a blurring solution for flexibly selecting the shape of the blur kernel, optimizes the lens blur solution for the media data, and realizes flexible selection of the shape of the blur kernel. Since the light spot in the target media data generated based on the blur kernel is associated with the shape of the blur kernel, the picture effect of the target media data is enriched by flexibly selecting the shape of the blur kernel.

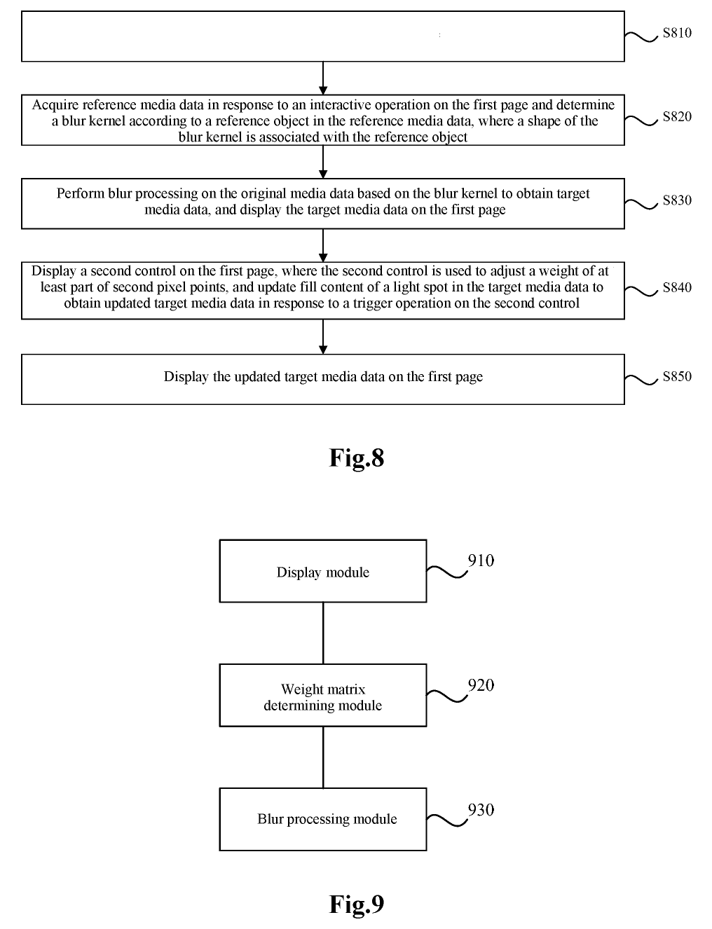

FIG. 8 is a schematic flowchart of another media data processing method according to an embodiment of the present disclosure. In the embodiment of the present disclosure, a blur kernel updating step is additionally defined on the basis of the above embodiments.

As shown in FIG. 8, the method includes:

S810, original media data is displayed on a first page.

S820, reference media data is acquired in response to an interactive operation on the first page and a blur kernel is determined according to a reference object in the reference media data, where a shape of the blur kernel is associated with the reference object.

Exemplarily, a reference picture is acquired in response to a material selection operation on the first page. The material selection operation includes drawing a reference picture, shooting a reference picture, uploading a reference picture, or the like. The reference picture includes the reference object. Optionally, a second page may be displayed in response to the material selection operation on the first page. The second page may be a local media resource library page, and the candidate media data is displayed on the local media resource library page. Alternatively, the second page may also be a drawing page, and the reference picture is acquired through the drawing page. Alternatively, the second page may also be a shooting page, and the reference picture is acquired through the shooting page.

A binarization result of the reference picture is determined. A weight matrix corresponding to the reference object is determined according to luminance values of pixel points of the reference object in the binarization result.

Optionally, determining the weight matrix corresponding to the reference object according to the luminance values of the pixel points of the reference object in the binarization result includes: determining a first pixel point set and a second pixel point set in the binarization result, where a first pixel point in the first pixel point set represents a pixel point on a contour of the reference object, and a second pixel point in the second pixel point set represents a pixel point within the contour of the reference object; determining a weight of the first pixel point according to a luminance value of the first pixel point; determining a weight of the second pixel point according to a luminance value of the second pixel point; and determining the weight matrix corresponding to the reference object according to positions and weights corresponding to the first pixel point and the second pixel point.

At least part of the weights in the weight matrix corresponding to the reference object are adjusted according to a preset adjustment coefficient, and the blur kernel is determined according to the adjusted weight matrix.

S830, blur processing is performed on the original media data based on the blur kernel to obtain target media data, and the target media data is displayed on the first page.

Optionally, the luminance value includes a luminance value of the first pixel point or the second pixel point associated with at least one color channel, and the weight matrix represents a weight matrix associated with the at least one color channel.

Exemplarily, based on the weight matrix associated with the at least one color channel, convolution processing is performed on a luminance value of a color channel corresponding to the original media data to obtain a convolution result of the at least one color channel of the original media data; and the target media data is determined according to the convolution result of the at least one color channel of the original media data.

S840, a second control is displayed on the first page, where the second control is used to adjust a weight of at least part of the second pixel points, and fill content of a light spot in the target media data is updated to obtain updated target media data in response to a trigger operation on the second control.

Exemplarily, a weight adjustment amount of at least part of the second pixel points is determined in response to the trigger operation on the second control, and the weight matrix is updated according to the weight adjustment amount to obtain an updated weight matrix. Blur processing is performed on the original media data based on the updated weight matrix to obtain the updated target media data.

In some embodiments, the weight adjustment amount and an adjustment range of the second pixel point are determined in response to the trigger operation on the second control. In a case that the adjustment range is full adjustment, the weight corresponding to the second pixel point in the weight matrix is updated according to the weight adjustment amount to obtain the updated weight matrix. In a case that the adjustment range is local adjustment, the weight corresponding to the second pixel point in the local area in the weight matrix is updated according to the weight adjustment amount to obtain the updated weight matrix.

For example, the second control may be a control that represents the weight adjustment amount by a sliding amount. Alternatively, the second control may include a weight adjustment amount option and the like. Optionally, the second control includes at least one sub-control, and the sub-control is associated with pixel points in different areas in the reference object. For example, the second control includes a first sub-control and a second sub-control. The first sub-control is associated with an edge contour area of the blur kernel represented by the weight matrix. The second sub-control is associated with an area within the contour of the blur kernel.

Determining the weight adjustment amount of at least part of the second pixel points in response to the trigger operation on the second control and updating the weight matrix according to the weight adjustment amount to obtain the updated weight matrix includes:

determining a weight adjustment range according to an area associated with the at least one sub-control in response to a trigger operation on the at least one sub-control; and determining the weight adjustment amount according to a sliding amount or an option associated with the at least one sub-control; and updating a weight of a pixel point in a corresponding area in the weight matrix according to the weight adjustment range and the weight adjustment amount to obtain the updated weight matrix.

Convolution processing is performed on the luminance value of the original media data based on the updated weight matrix to obtain the updated target media data.

S850, the updated target media data is displayed on the first page.

In the technical solution of the embodiment of the present disclosure, the weight adjustment amount of at least part of the second pixel points is determined in response to the trigger operation on the second control, the corresponding weight in the weight matrix is updated according to the weight adjustment amount to obtain the updated weight matrix, and the blur processing is performed on the original media data based on the updated weight matrix to obtain the updated target media data, so as to display the updated target media data on the first page. According to the embodiment of the present disclosure, a solution of conveniently modifying the blur kernel may be realized, and then the effect of the light spot in the target media data displayed on the first page may be adjusted, thereby further enriching the picture effect.

FIG. 9 is a schematic diagram of a structure of a media data processing apparatus according to an embodiment of the present disclosure. The apparatus may be implemented in the form of software and/or hardware, and optionally, by an electronic device which may be a mobile terminal, a PC, a server, etc. As shown in FIG. 9, the apparatus includes: a displaying module 910, a weight matrix determining module 920, and a blur processing module 930.

The displaying module 910 is configured to display original media data on a first page;

the weight matrix determining module 920 is configured to acquire reference media data in response to an interactive operation on the first page and determine a blur kernel according to a reference object in the reference media data, where a shape of the blur kernel is associated with the reference object; and

the blur processing module 930 is configured to perform blur processing on the original media data based on the blur kernel to obtain target media data, and display the target media data on the first page, where a shape of a light spot in the target media data is associated with the reference object.

Optionally, the weight matrix determining module 920 is further configured to:

further display a first control on the first page;

display a second page in response to a trigger operation on the first control, where the second page includes candidate media data, and the candidate media data includes the reference media data; and

acquire the reference media data in response to an interactive operation on the second page.

Optionally, the weight matrix determining module 920 is further configured to:

determine a binarization result of the reference media data;

determine a weight matrix corresponding to the reference object according to luminance values of pixel points of the reference object in the binarization result; and

determine the blur kernel according to the weight matrix corresponding to the reference object.

Optionally, determining the weight matrix corresponding to the reference object according to the luminance values of the pixel points of the reference object in the binarization result includes:

determining a first pixel point set and a second pixel point set in the binarization result, where a first pixel point in the first pixel point set represents a pixel point on a contour of the reference object, and a second pixel point in the second pixel point set represents a pixel point within the contour of the reference object;

determining a weight of the first pixel point according to a luminance value of the first pixel point;

determining a weight of the second pixel point according to a luminance value of the second pixel point; and

determining the weight matrix corresponding to the reference object according to positions and weights corresponding to the first pixel point and the second pixel point.

Optionally, the luminance value includes a luminance value associated with the first pixel point or the second pixel point and at least one color channel, and the weight matrix represents a weight matrix associated with the at least one color channel.

Optionally, the blur processing module 930 is further configured to:

based on the weight matrix associated with the at least one color channel, perform convolution processing on a luminance value of a color channel corresponding to the original media data to obtain a convolution result of the at least one color channel of the original media data; and

determine the target media data according to the convolution result of the at least one color channel of the original media data.

Optionally, determining the blur kernel according to the weight matrix corresponding to the reference object includes:

adjusting at least part of the weights in the weight matrix corresponding to the reference object according to a preset adjustment coefficient, and determining the blur kernel according to the adjusted weight matrix.

Optionally, the first page further includes a second control, and the second control is used to adjust a weight of at least part of the second pixel points; and the apparatus further includes:

updating fill content of a light spot in the target media data to obtain updated target media data in response to a trigger operation on the second control; and

displaying the updated target media data on the first page.

Optionally, updating the fill content of the light spot in the target media data to obtain the updated target media data in response to the trigger operation on the second control includes:

determining a weight adjustment amount of at least part of the second pixel points in response to the trigger operation on the second control, and updating the weight matrix according to the weight adjustment amount to obtain an updated weight matrix; and

performing blur processing on the original media data based on the updated weight matrix to obtain the updated target media data.

The media data processing apparatus provided by the embodiment of the present disclosure may perform the media data processing method provided by any embodiment of the present disclosure, and has corresponding functional modules and beneficial effects for performing the method.

It is worth noting that the units and modules included in the above apparatus are only divided according to functional logic but are not limited to the above division, as long as the corresponding functions may be implemented; in addition, the specific names of the functional units are only for the convenience of distinguishing between each other and are not used to limit the scope of protection of the embodiments of the present disclosure.

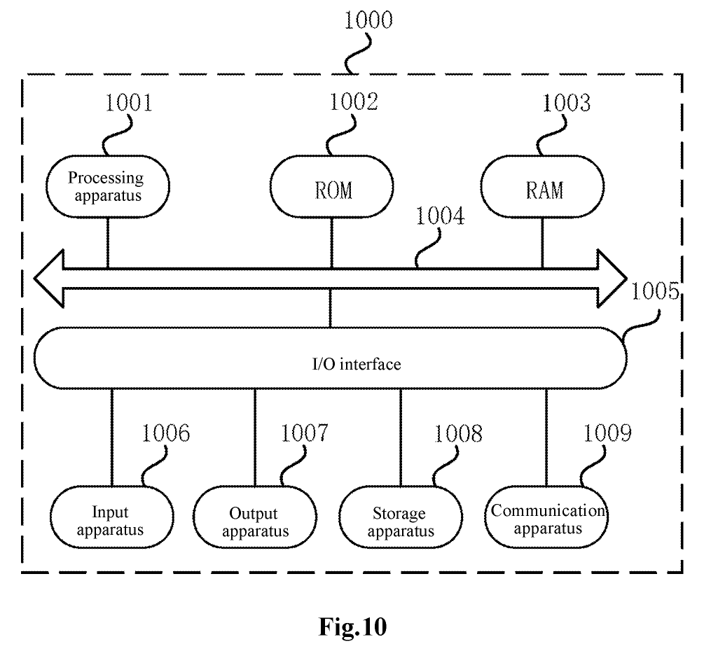

FIG. 10 is a schematic diagram of a structure of an electronic device according to an embodiment of the present disclosure. Reference is made to FIG. 10 below, which illustrates a schematic diagram of a structure of an electronic device (for example, a terminal device or a server in FIG. 10) 1000 suitable for implementing the embodiments of the present disclosure. The terminal device in the embodiments of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 10 is only an example and should not impose any limitation on the function and scope of use of the embodiments of the present disclosure.

As shown in FIG. 10, the electronic device 1000 may include a processing apparatus (such as a central processing unit and a graphics processing unit) 1001 that may perform various suitable actions and processing according to a program stored in a read-only memory (ROM) 1002 or a program loaded from a storage apparatus 1008 into a random access memory (RAM) 1003. The RAM 1003 further stores various programs and data required for operations of the electronic device 1000. The processing apparatus 1001, the ROM 1002, and the RAM 1003 are connected to each other through a bus 1004. An editing/output (I/O) interface 1005 is also connected to the bus 1004.

Usually, the following apparatuses may be connected to the I/O interface 1005: an input apparatus 1006 including, for example, a touch screen, a touchpad, a keyboard, a mouse, a camera, a microphone, an accelerometer, and a gyroscope; an output apparatus 1007 including, for example, a liquid crystal display (LCD), a speaker, and a vibrator; the storage apparatus 1008 including, for example, a magnetic tape and a hard disk; and a communication apparatus 1009. The communication apparatus 1009 may allow the electronic device 1000 to perform wireless or wired communication with other devices to exchange data. Although FIG. 10 shows the electronic device 1000 having various apparatuses, it is to be understood that not all of the illustrated apparatuses are necessarily implemented or included. More or fewer apparatuses may be implemented or provided alternatively.

In particular, according to an embodiment of the present disclosure, the process described above with reference to the flowchart may be implemented as a computer software program. For example, the embodiment of the present disclosure includes a computer program product, which includes a computer program carried on a non-transitory computer-readable medium, where the computer program includes program code for performing the method illustrated in the flowchart. In such an embodiment, the computer program may be downloaded and installed from a network via the communication apparatus 1009, or installed from the storage apparatus 1008, or installed from the ROM 1002. When the computer program is executed by the processing apparatus 1001, the aforementioned functions defined in the method of the embodiment of the present disclosure are executed.

The names of messages or information exchanged between a plurality of apparatuses in the implementations of the present disclosure are for illustrative purposes only and are not intended to limit the scope of these messages or information.

The electronic device provided by the embodiment of the present disclosure belongs to the same inventive concept as the media data processing method provided by the above embodiment. For technical details not described in detail in this embodiment, reference may be made to the above embodiment, and this embodiment has the same beneficial effects as the above embodiment.

An embodiment of the present disclosure provides a computer storage medium having a computer program stored thereon, where when the program is executed by a processor, the media data processing method provided by the above embodiment is implemented.

It is to be noted that the above computer-readable medium in the present disclosure may be a computer-readable signal medium, a computer-readable storage medium, or any combination thereof. The computer-readable storage medium may be, for example, but is not limited to, an electronic, magnetic, optical, electromagnetic, infrared, or semiconductor system, apparatus, or device, or any combination thereof. More specific examples of the computer-readable storage medium may include, but are not limited to, an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program, which may be used by or in combination with an instruction execution system, apparatus, or device. In the present disclosure, the computer-readable signal medium may include a data signal propagated on a baseband or as a part of a carrier, and computer-readable program code is carried therein. The data signal propagated in this manner may be in a plurality of forms and includes, but is not limited to, an electromagnetic signal, an optical signal, or any suitable combination thereof. The computer-readable signal medium may also be any computer-readable medium other than the computer-readable storage medium, and the computer-readable signal medium may send, propagate, or transmit the program used by or in combination with the instruction execution system, apparatus, or device. The program code contained on the computer-readable medium may be transmitted in any suitable medium, including but not limited to a wire, an optical cable, a radio frequency (RF), or any suitable combination thereof.

In some implementations, clients and servers may communicate using any currently known or future developed network protocol, such as the hypertext transfer protocol (HTTP), and may be interconnected with any form or medium of digital data communication (for example, a communication network). Examples of the communication network include a local area network ("LAN"), a wide area network ("WAN"), an internet (for example, the Internet), a peer-to-peer network (for example, an Ad-Hoc network), and any network currently known or to be developed in the future.

The computer-readable medium may be contained in the electronic device or may exist alone without being assembled into the electronic device.

The above computer-readable medium carries one or more programs that, when executed by the electronic device, cause the electronic device to:

display original media data on a first page;

acquire reference media data in response to an interactive operation on the first page and determine a blur kernel according to a reference object in the reference media data, where a shape of the blur kernel is associated with the reference object; and

perform blur processing on the original media data based on the blur kernel to obtain target media data, and display the target media data on the first page.

The computer program code for performing the operations of the present disclosure may be written in one or more programming languages or a combination thereof, where the programming languages include, but are not limited to, object-oriented programming languages, such as Java, Smalltalk, and C++, and further include conventional procedural programming languages, such as "C" language or similar programming languages. The program code may be executed entirely on a user's computer, partly executed on a user's computer, executed as an independent software package, partly executed on a user's computer and partly executed on a remote computer, or entirely executed on a remote computer or a server. In the case involving the remote computer, the remote computer may be connected to the user's computer through any kind of network, including a local area network (LAN) or a wide area network (WAN), or may be connected to an external computer (for example, connected via the Internet using an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, which includes one or more executable instructions for implementing the specified logical functions. It is also to be noted that, in some alternative implementations, the functions indicated in the blocks may also occur in an order different from that indicated in the drawings. For example, two blocks shown in succession may actually be executed substantially in parallel, or they may sometimes be executed in the reverse order, depending on the functions involved. It is also to be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units involved in the embodiments of the present disclosure may be implemented by means of software, and may also be implemented by means of hardware. The name of a unit does not constitute a limitation on the unit itself under certain circumstances, for example, the first acquisition unit may also be described as "a unit for acquiring at least two internet protocol addresses".

The functions described herein above may be performed, at least in part, by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The above description is only preferred embodiments of the present disclosure and an explanation of the applied technical principles. Those skilled in the art should understand that the scope of disclosure involved in the present disclosure is not limited to the technical solutions formed by the specific combination of the above technical features, but also covers other technical solutions formed by any combination of the above technical features or their equivalent features without departing from the above concept of disclosure. For example, the above features and the technical features disclosed in the present disclosure (but not limited to) with similar functions may replace each other to form a technical solution.

In addition, although the operations are depicted in a particular order, this should not be understood as requiring the operations to be performed in the particular order shown or in a sequential order. Under certain circumstances, multitasking and parallel processing may be advantageous. Likewise, although several specific implementation details are included in the above discussion, these should not be construed as limiting the scope of the present disclosure. Certain features that are described in the context of separate embodiments may also be implemented in combination in a single embodiment. Conversely, various features described in the context of a single embodiment may also be implemented in a plurality of embodiments individually or in any suitable sub-combination.

Although the subject matter has been described in language specific to structural features and/or logical actions of the method, it is to be understood that the subject matter defined in the appended claims is not necessarily limited to the specific features or actions described above. Conversely, the specific features and actions described above are merely exemplary forms of implementing the claims.

We claim:

1. A media data processing method, comprising:
displaying original media data on a first page;
acquiring reference media data in response to an interactive operation on the first page, and determining a blur kernel based on a reference object in the reference media data, wherein a shape of the blur kernel is associated with the reference object; and
performing blur processing on the original media data based on the blur kernel to obtain target media data, and displaying the target media data on the first page.

2. The method of claim 1, wherein acquiring the reference media data in response to the interactive operation on the first page comprises:
displaying a first control on the first page;
displaying a second page in response to a trigger operation on the first control, wherein the second page comprises candidate media data, and the candidate media data comprises the reference media data; and
acquiring the reference media data in response to an interactive operation on the second page.

3. The method of claim 1, wherein determining the blur kernel based on the reference object in the reference media data comprises:
determining a binarization result of the reference media data;
determining a weight matrix corresponding to the reference object based on luminance values of pixel points of the reference object in the binarization result; and
determining the blur kernel based on the weight matrix corresponding to the reference object.

4. The method of claim 3, wherein determining the weight matrix corresponding to the reference object based on the luminance values of the pixel points of the reference object in the binarization result comprises:
determining a first pixel point set and a second pixel point set in the binarization result, wherein a first pixel point in the first pixel point set represents a pixel point on a contour of the reference object, and a second pixel point in the second pixel point set represents a pixel point within the contour of the reference object;
determining a weight of the first pixel point based on a luminance value of the first pixel point;
determining a weight of the second pixel point based on a luminance value of the second pixel point; and
determining the weight matrix corresponding to the reference object based on positions and the weights corresponding to the first pixel point and the second pixel point.

5. The method of claim 4, wherein the luminance value comprises a luminance value of the first pixel point or the second pixel point associated with at least one color channel, and the weight matrix represents a weight matrix associated with the at least one color channel.

6. The method of claim 5, wherein performing the blur processing on the original media data based on the blur kernel to obtain the target media data comprises:
performing, based on the weight matrix associated with the at least one color channel, convolution processing on a luminance value of a color channel corresponding to the original media data to obtain a convolution result of the at least one color channel of the original media data; and
determining the target media data based on the convolution result of the at least one color channel of the original media data.

7. The method of claim 3, wherein determining the blur kernel based on the weight matrix corresponding to the reference object comprises:
adjusting at least part of weights in the weight matrix corresponding to the reference object based on a preset adjustment coefficient, and determining the blur kernel based on the adjusted weight matrix.

8. The method of claim 5, wherein the first page further comprises a second control, and the second control is used for adjusting a weight of at least part of the second pixel points; and the method further comprises:
updating, in response to a trigger operation on the second control, fill content of a light spot in the target media data to obtain updated target media data; and
displaying the updated target media data on the first page.

9. The method of claim 8, wherein updating, in response to a trigger operation on the second control, the fill content of the light spot in the target media data to obtain the updated target media data comprises:
determining a weight adjustment amount of at least part of the second pixel points in response to the trigger operation on the second control, and updating the weight matrix based on the weight adjustment amount to obtain an updated weight matrix; and
performing the blur processing on the original media data based on the updated weight matrix to obtain the updated target media data.

10. An electronic device, comprising:
one or more processors;
a storage, configured to store one or more programs, wherein the one or more programs, when executed by the one or more processors, cause the one or more processors to:
display original media data on a first page;
acquire reference media data in response to an interactive operation on the first page, and determine a blur kernel based on a reference object in the reference media data, wherein a shape of the blur kernel is associated with the reference object; and
perform blur processing on the original media data based on the blur kernel to obtain target media data, and display the target media data on the first page.

11. The electronic device according to claim 10, wherein the one or more programs causing the one or more processors to acquire the reference media data in response to the interactive operation on the first page further cause the processors to:
display a first control on the first page;
display a second page in response to a trigger operation on the first control, wherein the second page comprises candidate media data, and the candidate media data comprises the reference media data; and
acquire the reference media data in response to an interactive operation on the second page.

12. The electronic device according to claim 10, wherein the one or more programs causing the one or more processors to determine the blur kernel based on the reference object in the reference media data further cause the processors to:
determine a binarization result of the reference media data;
determine a weight matrix corresponding to the reference object based on luminance values of pixel points of the reference object in the binarization result; and
determine the blur kernel based on the weight matrix corresponding to the reference object.

13. The electronic device according to claim 12, wherein the one or more programs causing the one or more processors to determine the weight matrix corresponding to the reference object based on the luminance values of the pixel points of the reference object in the binarization result further cause the processors to:
determine a first pixel point set and a second pixel point set in the binarization result, wherein a first pixel point in the first pixel point set represents a pixel point on a contour of the reference object, and a second pixel point in the second pixel point set represents a pixel point within the contour of the reference object;
determine a weight of the first pixel point based on a luminance value of the first pixel point;
determine a weight of the second pixel point based on a luminance value of the second pixel point; and
determine the weight matrix corresponding to the reference object based on positions and the weights corresponding to the first pixel point and the second pixel point.

14. The electronic device according to claim 13, wherein the luminance value comprises a luminance value of the first pixel point or the second pixel point associated with at least one color channel, and the weight matrix represents a weight matrix associated with the at least one color channel.

15. The electronic device according to claim 14, wherein the one or more programs causing the one or more processors to perform the blur processing on the original media data based on the blur kernel to obtain the target media data further cause the processors to:
perform, based on the weight matrix associated with the at least one color channel, convolution processing on a luminance value of a color channel corresponding to the original media data to obtain a convolution result of the at least one color channel of the original media data; and
determine the target media data based on the convolution result of the at least one color channel of the original media data.

16. The electronic device according to claim 12, wherein the one or more programs causing the one or more processors to determine the blur kernel based on the weight matrix corresponding to the reference object further cause the processors to:
adjust at least part of weights in the weight matrix corresponding to the reference object based on a preset adjustment coefficient, and determine the blur kernel based on the adjusted weight matrix.

17. The electronic device according to claim 14, wherein the first page further comprises a second control, and the second control is used for adjusting a weight of at least part of the second pixel points; and the one or more programs further cause the one or more processors to:
update, in response to a trigger operation on the second control, fill content of a light spot in the target media data to obtain updated target media data; and
display the updated target media data on the first page.

18. The electronic device according to claim 17, wherein the one or more programs causing the one or more processors to update, in response to a trigger operation on the second control, the fill content of the light spot in the target media data to obtain the updated target media data further cause the processors to:
determine a weight adjustment amount of at least part of the second pixel points in response to the trigger operation on the second control, and update the weight matrix based on the weight adjustment amount to obtain an updated weight matrix; and
perform the blur processing on the original media data based on the updated weight matrix to obtain the updated target media data.

19. A non-transitory storage medium comprising computer-executable instructions, wherein the computer-executable instructions, when executed by a computer processor, cause a computer to:
display original media data on a first page;
acquire reference media data in response to an interactive operation on the first page, and determine a blur kernel based on a reference object in the reference media data, wherein a shape of the blur kernel is associated with the reference object; and
perform blur processing on the original media data based on the blur kernel to obtain target media data, and display the target media data on the first page.

20. The non-transitory storage medium according to claim 19, wherein the instructions to acquire the reference media data in response to the interactive operation on the first page comprise instructions to:
display a first control on the first page;
display a second page in response to a trigger operation on the first control, wherein the second page comprises candidate media data, and the candidate media data comprises the reference media data; and
acquire the reference media data in response to an interactive operation on the second page.
